(19) United States
(12) Patent Application Publication
(10) Pub. No.: US 2018/0082066 A1
(43) Pub. Date: Mar. 22, 2018

(54) SECURE DATA ERASURE IN HYPERSCALE COMPUTING SYSTEMS

(71) Applicant: Microsoft Technology Licensing, LLC, Redmond, WA (US)

(72) Inventors: Ashish Munjal, Redmond, WA (US); Laura Caulfield, Woodinville, WA (US); Lee Progl, Carnation, WA (US); Uuganjargal Khanna, Kirkland, WA (US)

(21) Appl. No.: 15/268,375

(22) Filed: Sep. 16, 2016

(51) Int. Cl. G06F 21/60; H04L 12/24; H04L 29/08

(52) U.S. Cl. CPC G06F 21/60; G06F 2221/2143; H04L 67/10; H04L 41/28

(57) ABSTRACT

Techniques of implementing out-of-band secure data erasure in computing systems are disclosed herein. In one embodiment, a method includes receiving an erasure instruction from a system administrator via a management network. In response to and based on the received erasure instruction, the method includes identifying one or more servers in the enclosure to which data erasure is to be performed and transmitting an erasure command to the individual one or more identified servers via a network interface between the computing device and the individual servers. The erasure command instructs the identified servers to perform secure data erasure on one or more persistent storage devices of the identified servers to securely erase data residing on the one or more persistent storage devices without manual intervention.

### BACKGROUND

Datacenters and other computing systems typically include routers, switches, bridges, and other physical network devices that interconnect a large number of servers, network storage devices, and other types of computing devices. The individual servers can host one or more virtual machines or other types of virtualized components. The virtual machines can execute applications when performing desired tasks to provide cloud computing services to users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Cloud computing systems can include thousands, tens of thousands, or even millions of servers housed in racks, containers, or other enclosures. Each server can include, for example, a motherboard containing one or more processors or “cores,” volatile memory (e.g., dynamic random access memory), persistent storage devices (e.g., hard disk drives, solid state drives, etc.), network interface cards, or other suitable hardware components. The foregoing hardware components typically have useful lives beyond which reliability may not be expected or guaranteed. As such, the servers or hardware components thereof may need to be replaced every four, five, six, or other suitable numbers of years.

One challenge of replacing expiring or expired hardware components is ensuring data security. Certain servers can contain multiple persistent storage devices containing data with various levels of business importance. One technique of ensuring data security is to physically remove the persistent storage devices from the servers and mechanically damaging the removed persistent storage devices (e.g., via hole punching). Another technique can involve a technician manually connecting the servers or a rack of servers to a custom computer having an application specifically designed to perform data erasure. The technician can then erase all data on the servers using the application. Both of the foregoing techniques, however, are labor intensive, time consuming, and thus costly. As such, resources such as space, power, network bandwidth can be wasted while in computing systems while waiting for replacement of the hardware components. In addition, applying mechanical damage can render persistent storage devices non-recyclable and thus generate additional landfill wastes.

Several embodiments of the disclosed technology can address several aspects of the foregoing challenge by implementing out-of-band secure data erasure in computing systems. In certain implementations, a computing system can include both a data network and an independent management network. The data network can be configured to allow communications related to performing data processing, network communications, or other suitable tasks in providing desired computing services to users. In contrast, a management network can be configured to perform management functions, example of which can include operation monitoring, power operations (e.g., power-up/down/cycle of servers), or other suitable operations. The management network can be separate and independent from the data network, for example, by utilizing separate wired and/or wireless communications media than the data network.

In certain implementations, an enclosure (e.g., a rack, a container, etc.) can include an enclosure controller operatively coupled to multiple servers housed in the enclosure. During secure erasure, while the servers are disconnected from the data network, an administrator can issue an erasure instruction to the enclosure controller to perform erasure on one or more servers in the enclosure via the management network. In response, the enclosure controller can identify the one or more servers based on serial numbers, server locations, or other suitable identification parameters.

The enclosure controller can then issue an erasure command to each of the one or more servers. In response, a baseboard management controller (“BMC”) or other suitable components of the servers can enumerate a portion of or all persistent storage devices that the BMC is aware of to be on the server. The BMC can then command each of the persistent storage device to erase data contained thereon. In certain embodiments, data erasure can involve formatting the persistent storage devices once, twice, or any suitable number of times based on, for example, a level of business importance of the data contained thereon. In other embodiments, data erasure can also include writing a predetermined pattern (e.g., all zeros or all ones) in all sections of the persistent storage devices. In further embodiments, data erasure can also involve intentionally operating the persistent storage devices under abnormal conditions (e.g., by commanding a hard disk drive to overspin) and as a result, causing electrical/mechanical damage to the persistent storage devices. The BMCs can also report failure or completion of the secure data erasure to the enclosure controller, which in turn aggregate and reports the erasure results to the administrator via the management network.

In other implementations, the enclosure controller can be an originating enclosure controller configured to propagate or distribute the received erasure instruction to additional enclosure controllers in the same or other enclosures via the management network. In turn, the additional enclosure controllers can instruct corresponding BMC(s) to perform secure data erasure and report erasure result to the originating enclosure controller. The originating enclosure controller can then aggregate and report the erasure results to the administrator via the management network. In further implementations, the administrator can separately issue an erasure instruction to each of the enclosure controllers instead of utilizing the originating enclosure controller. In yet further implementations, the foregoing operations can be performed by a datacenter controller, a fabric controller, or other suitable types of controller via the management network in lieu of the enclosure controller.

Several embodiments of the disclosed technology can efficiently and cost-effectively perform secure data erasure on multiple servers in computing systems. For example, relaying the erasure instructions via the enclosure controllers can allow performance of secure data erasure of multiple servers, racks of servers, or clusters of servers in parallel, staggered, or in other suitable manners. Also, the foregoing secure data erasure technique generally does not involve manual intervention by technicians. As such, several embodiments of the disclosed secure data erasure can be efficient and cost effective.

### BRIEF DESCRIPTION OF THE DRAWINGS

FIG. 1 is a schematic diagram illustrating a computing system implemented with out-of-band secure data erasure in accordance with embodiments of the disclosed technology.

FIGS. 2A-2D are schematic diagrams illustrating the computing system of FIG. 1 during certain stages of performing secure data erasure via a management network in accordance with embodiments of the disclosed technology.

FIGS. 3A-3B are block diagrams illustrating certain hardware/software components of a computing unit suitable for the computing system of FIG. 1 during certain stages of secure data erasure in accordance with embodiments of the disclosed technology.

FIG. 4 is a block diagram of the enclosure controller suitable for the computing system in FIG. 1 in accordance with embodiments of the disclosed technology.

FIG. 5 is a block diagram of a baseboard management controller suitable for the computing unit in FIG. 1 in accordance with embodiments of the disclosed technology.

FIGS. 6 and 7 are flowcharts illustrating processes of performing secure data erasure in a computing system in accordance with embodiments of the disclosed technology.

FIG. 8 is a computing device suitable for certain components of the computing system in FIG. 1.

### DETAILED DESCRIPTION

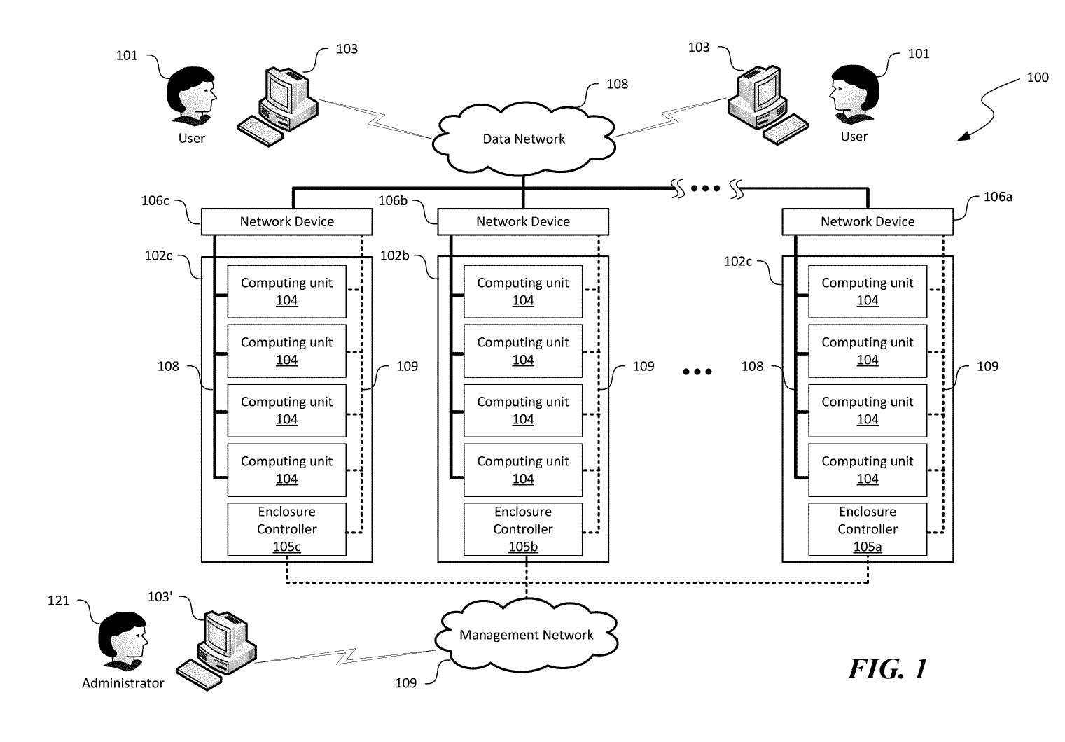

Certain embodiments of systems, devices, components, modules, routines, data structures, and processes for implementing out-of-band secure data erasure in computing systems are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-8.

As used herein, the term a “computing system” generally refers to an interconnected computer network having a plurality of network nodes that connect a plurality of servers or computing units to one another or to external networks (e.g., the Internet). The term “network node” generally refers to a physical network device. Example network nodes include routers, switches, hubs, bridges, load balancers, security gateways, or firewalls. A “computing unit” generally refers to a computing device configured to implement, for instance, one or more virtual machines or other suitable network-accessible services. For example, a computing unit can include a server having a hypervisor configured to support one or more virtual machines or other suitable types of virtual components. In another example, a computing unit can also include a network storage server having ten, twenty, thirty, forty, or other suitable number of persistent storage devices thereon.

The term a “data network” generally refers to a computer network that interconnects multiple computing units to one another in a computing system and to an external network (e.g., the Internet). The data network allows communications among the computing units and between a computing unit and one or more client devices for providing suitable network-accessible services to users. For example, in certain embodiments, the data network can include a computer network interconnecting the computing units with client devices operating according to the TCP/IP protocol. In other embodiments, the data network can include other suitable types of computer network.

In contrast, the term “management network” generally refers to a computer network for communicating with and controlling device operations of computing units independent of execution of any firmware (e.g., BIOS) or operating system of the computing units. The management network is independent from the data network by employing, for example, separate wired and/or wireless communications media. A system administrator can monitor operating status of various computing units by receiving messages from the computing units via the management network in an out-of-band fashion. The messages can include current and/or historical operating conditions or other suitable information associated with the computing units. The system administrator can also issue instructions to the computing units to cause the computing units to power up, power down, reset, power cycle, refresh, and/or perform other suitable operations in the absence of any operating systems on the computing units. Communications via the management network are referred to herein as “out-of-band” communications while communications via the data network are referred to as “in-band” communications.

Also used herein, the terms “secure data erasure,” “data erasure,” “data clearing,” or “data wiping,” all generally refer to a software-based operation of overwriting data on a persistent storage device that aims to completely destroy all electronic data residing on the persistent storage device. Secure data erasure typically goes beyond basic file deletion, which only removes direct pointers to certain disk sectors and thus allowing data recovery. Unlike degaussing or physical destruction, which can render a storage media unusable, secure data erasure can remove all data from a persistent storage device while leaving the persistent storage device operable, and thus preserving IT assets, and reducing landfill wastes. The term “persistent storage device” generally refers to a non-volatile computer memory that can retain stored data even without power. Examples of persistent storage device can include read-only memory (“ROM”), flash memory (e.g., NAND or NOR solid state drives or SSDs), and magnetic storage devices (e.g. hard disk drives or HDDs).

Maintaining datacenters or other computing systems can involve replacing servers, hard disk drives, or other hardware components periodically. One challenge of replacing expiring or expired hardware components is ensuring data security. Often, servers can contain data with various levels of business importance. Leaking such data can cause breach of privacy, confidentiality, or other undesirable consequences. One technique of ensuring data security is to physically remove persistent storage devices from servers and hole punching the removed persistent storage devices. However, such a technique can be quite inadequate because the technique is labor intensive, time consuming, and thus costly. Space, power, network bandwidth, or other types of resource can thus be wasted in computing systems while waiting for replacement of the hardware components. In addition, applying mechanical damage can render hardware components non-recyclable and thus generate additional landfill wastes.

Several embodiments of the disclosed technology can address several aspects of the foregoing challenge by implementing out-of-band secure data erasure in computing systems. In certain implementations, a computing system can include both a data network and an independent management network. The management network can be separate and independent from the data network, for example, by utilizing separate wired and/or wireless communications media than the data network. During secure erasure, while servers are disconnected from the data network, an administrator can issue an erasure instruction to a rack controller, a chassis manager, or other suitable enclosure controller to perform erasure on one or more servers in the enclosure via the management network. In response, the enclosure controller can identify the one or more servers based on serial numbers, server locations, or other suitable identification parameters and command each of the persistent storage device to erase data contained thereon. As such, data erasure can be securely performed without involving manual intervention by technicians, as described in more detail below with reference to FIGS. 1-8.

FIG. 1 is a schematic block diagram illustrating a computing system 100 having computing units 104 configured in accordance with embodiments of the disclosed technology. As shown in FIG. 1, the computing system 100 can include multiple computer enclosures 102 (identified as first, second, and third enclosure 102a, 102b, and 102c, respectively) individually housing computing units 104 interconnected by a data network 108 via network devices 106 (identified as first, second, and third network device 106a, 106b, and 106c, respectively). The data network 108 can also be configured to interconnect the individual computing units 104 with one or more client devices 103. Even though particular configurations of the computing system 100 are shown in FIG. 1, in other embodiments, the computing system 100 can also include additional and/or different components than those shown in FIG. 1.

The computer enclosures 102 can include structures with suitable shapes and sizes to house the computing units 104. For example, the computer enclosures 102 can include racks, drawers, containers, cabinets, and/or other suitable assemblies. In the illustrated embodiment of FIG. 1, four computing units 104 are shown in each computer enclosure 102 for illustration purposes. In other embodiments, individual computer enclosures 102 can also include twelve, twenty four, thirty six, forty eight, or any other suitable number of computing units 104. Though not shown in FIG. 1, in further embodiments, the individual computer enclosures 102 can also include power distribution units, fans, intercoolers, and/or other suitable electrical and/or mechanical components.

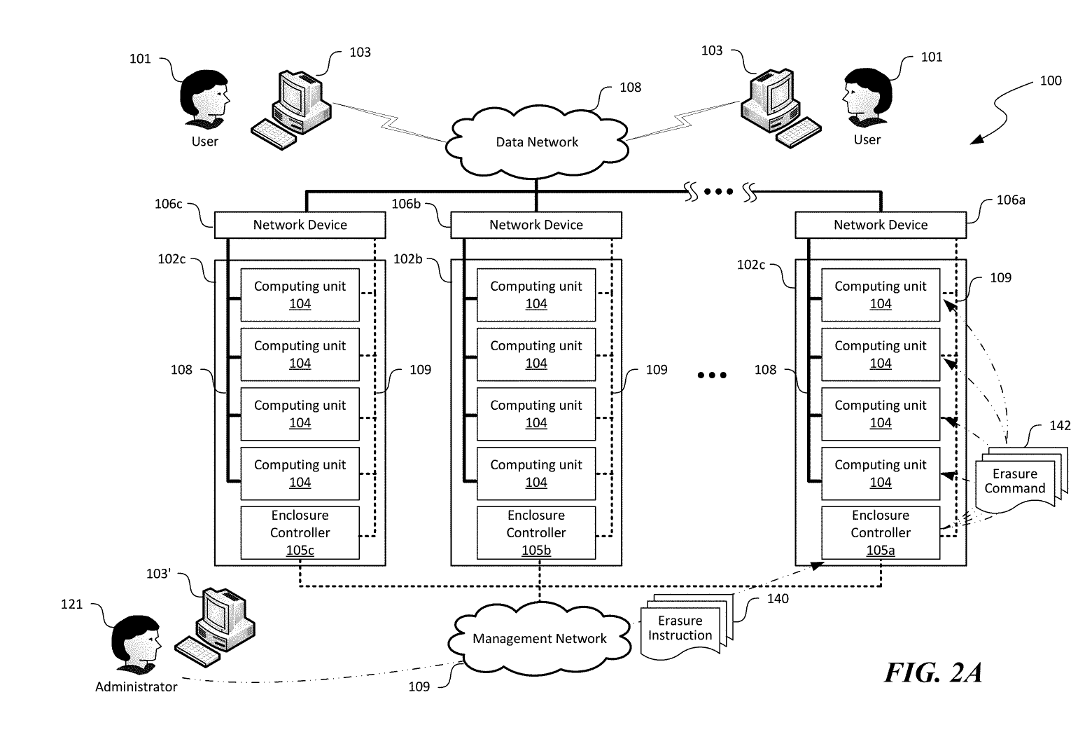

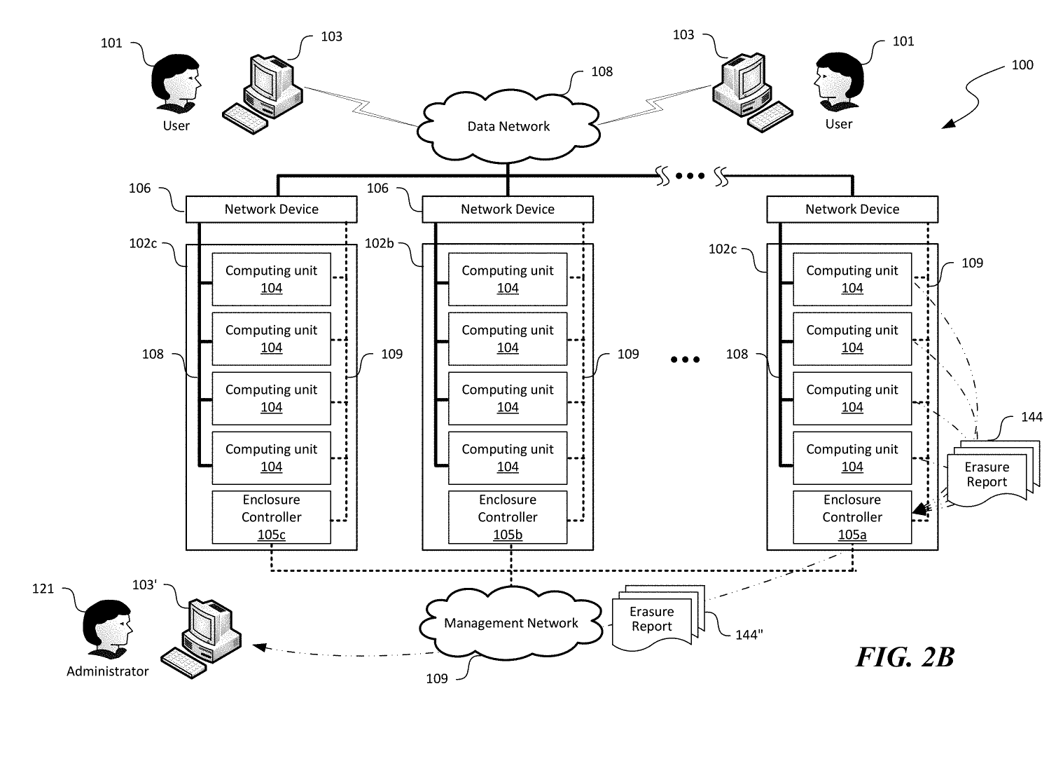

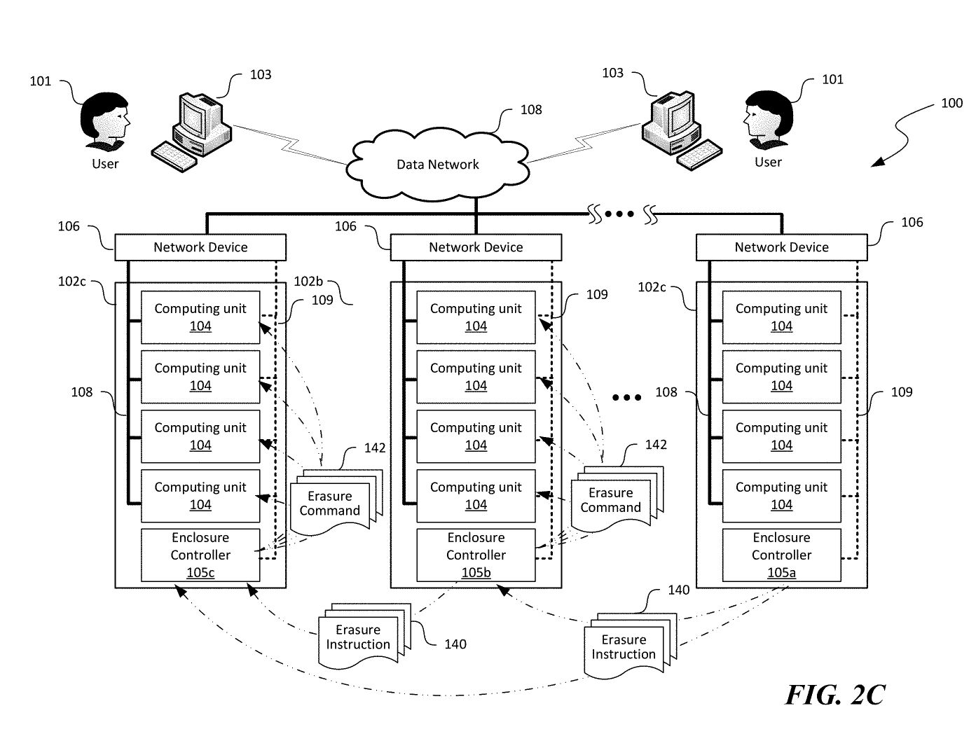

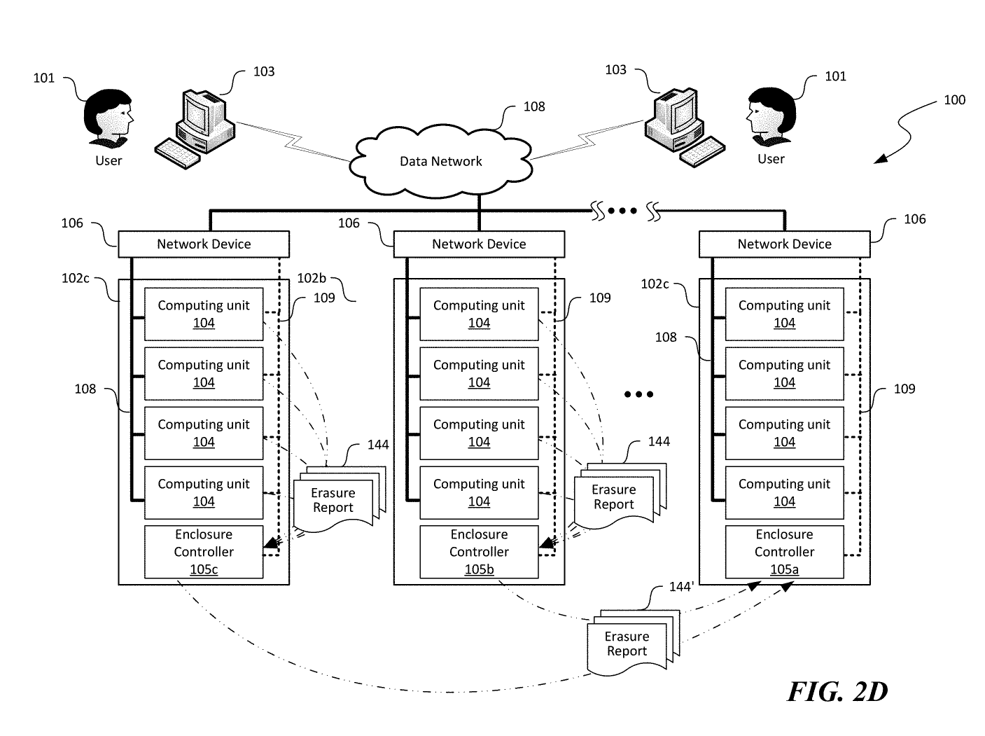

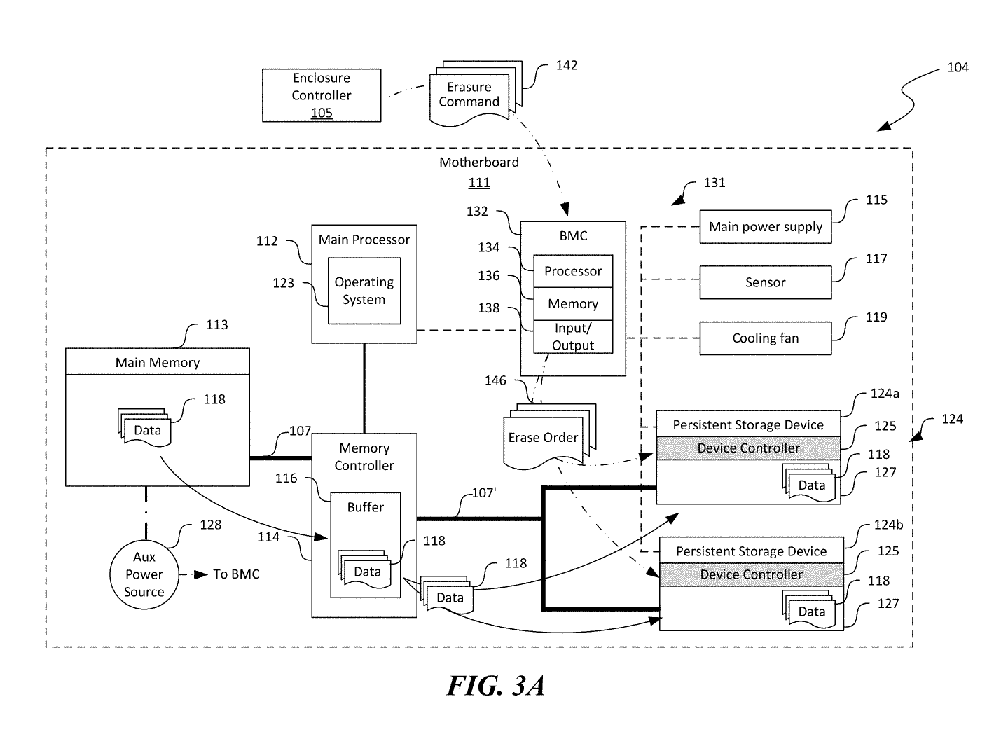

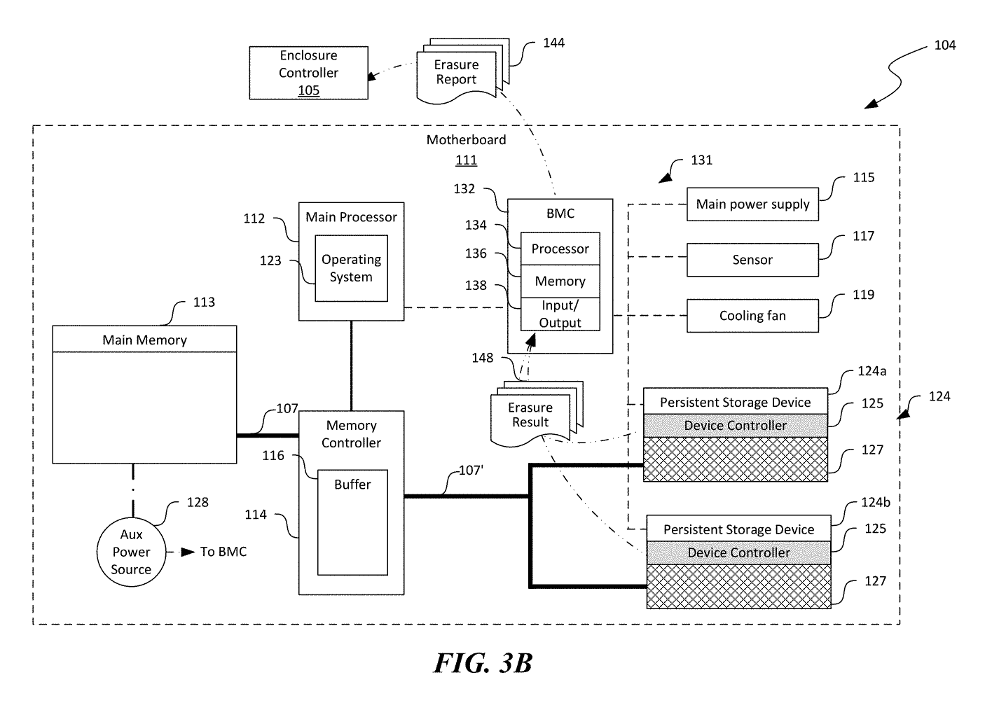

The computing units 104 can individually include one or more servers, network storage devices, network communications devices, or other suitable computing devices suitable for datacenters or other computing facilities. In certain embodiments, the computing units 104 can be configured to implement one or more cloud computing applications and/or services accessible by users 101 via the client device 103 (e.g., a desktop computer, a smartphone, etc.) via the data network 108. The computing units 104 can be individually configured to implement out-of-band secure data erasure in accordance with embodiments of the disclosed technology, as described in more detail below with reference to FIGS. 2A-3B.

As shown in FIG. 1, the individual computer enclosures 102 can also include an enclosure controller 105 (identified as first, second, and third enclosure controller 105a, 105b, and 105c, respectively) configured to monitor and/or control a device operation of the computing units 104, power distribution units, fans, intercoolers, and/or other suitable electrical and/or mechanical components. For example, the enclosure controllers 105 can be configured to power up, power down, reset, power cycle, refresh, and/or perform other suitable device operations on a particular computing unit 104 in a computer enclosure 102. In certain embodiments, the individual enclosure controllers 105 can include a rack controller configured to monitor operational status of the computing units 104 housed in a rack. One suitable rack controller is the Smart Rack Controller (EMX) provided by Raritan of Somerset, N.J. In other embodiments, the individual enclosure controllers 105 can include a chassis manager, a cabinet controller, a container controller, or other suitable types of controller. Though only one enclosure controller 105 is shown in each enclosure 102, in further embodiments, multiple enclosure controllers 105 (not shown) can reside in a single enclosure 102.

In the illustrated embodiment, the enclosure controllers 105 individually include a standalone server or other suitable types of computing device located in a corresponding computer enclosure 102. In other embodiments, the enclosure controllers 105 can include a service of an operating system or application running on one or more of the computing units 104 in the individual computer enclosures 102. In further embodiments, the in the individual computer enclosures 102 can also include remote server coupled to the computing units 104 via an external network (not shown) and/or the data network 108.

In certain embodiments, the data network 108 can include twisted pair, coaxial, untwisted pair, optic fiber, and/or other suitable hardwire communication media, routers, switches, and/or other suitable network devices. In other embodiments, the data network 108 can also include a wireless communication medium. In further embodiments, the data network 108 can include a combination of hardwire and wireless communication media. The data network 108 can operate according to Ethernet, token ring, asynchronous transfer mode, and/or other suitable link layer protocols. In the illustrated embodiment, the computing units 104 in the individual computer enclosure 102 are coupled to the data network 108 via the network devices 106 (e.g., a top-of-rack switch) individually associated with one of the computer enclosures 102. In other embodiments, the data network 108 may include other suitable topologies, devices, components, and/or arrangements.

As shown in FIG. 1, a management network 109 can also interconnect the computing units 104 in the computer enclosures 102, the enclosure controller 105, the network devices 106, and the management station 103′. The management network 109 can be independent from the data network 108. As used herein, the term “independent” in the context of networks generally refers to that operation of one network is not contingent on an operating condition of another network. As a result, the data network 108 and the management network 109 can operate irrespective of an operating condition of the other. In certain embodiments, the management station 103′ can include a desktop computer. In other embodiments, the management station 103′ can include a laptop computer, a tablet computer, or other suitable types of computing device via which an administrator 121 can access the management network 109.

In certain embodiments, the management network 109 can include twisted pair, coaxial, untwisted pair, optic fiber, and/or other suitable hardwire communication media, routers, switches, and/or other suitable network devices separate from those associated with the data network 108. In other embodiments, the management network 109 can also utilize terrestrial microwave, communication satellites, cellular systems, WI-FI, wireless LANs, Bluetooth, infrared, near field communication, ultra-wide band, free space optics, and/or other suitable types of wireless media. The management network 109 can also operate according to a protocol similar to or different from that of the data network 108. For example, the management network 109 can operate according to Simple Network Management Protocol (“SNMP”), Common Management Information Protocol (“CMIP”), or other suitable management protocols. In another example, the management network 109 can operate according to TCP/IP or other suitable network protocols. In the illustrated embodiment, the computing units 104 in the computer enclosures 102 are individually coupled (as shown with the phantom lines) to the corresponding enclosure controller 105 via the management network 109. In other embodiments, the computing units 104 may be coupled to the management network 109 in groups and/or may have other suitable network topologies.

In operation, the computing units 104 can receive requests from the users 101 using the client device 103 via the data network 108. For example, the user 101 can request a web search using the client device 103. After receiving the request, one or more of the computing units 104 can perform the requested web search and generate search results. The computing units 104 can then transmit the generated search results as network data to the client devices 103 via the data network 108 and/or other external networks (e.g., the Internet, not shown).

Independent from the foregoing operations, the administrator 121 can monitor operations of the network devices 106, the computing units 104, or other components in the computing system 101 via the management network 109. For example, the administrator 121 can monitor a network traffic condition (e.g., bandwidth utilization, congestion, etc.) through one or more of the network devices 106. The administrator 121 can also monitor for a high temperature condition, power event, or other status of the individual computing units 104. The administrator 121 can also turn on/off one or more of the computing devices 106 and/or computing units 104. As described in more detail below with reference to FIGS. 2A-3D, the computing system 100 can be implemented with out-of-band secure data erasure via the management network 109 in accordance with embodiments of the disclosed technology.

FIGS. 2A-2D are schematic diagrams illustrating the computing system 100 of FIG. 1 during certain stages of performing secure data erasure via a management network 109 in accordance with embodiments of the disclosed technology. In FIGS. 2A-2D, certain components of the computing system 100 may be omitted for clarity. Also, in FIG. 2A-2D and other figures herein, similar reference numbers designate similar components in structure and function.

FIG. 2A illustrate an initial stage of performing secure data erasure in the first computer enclosure 102a in the computing system 100. As shown in FIG. 2A, an administrator 121 can determine that replacement of one or more computing units 104 in the first computer enclosure 102a is due. In response, the administrator 121, with proper authentication and confirmation, can disconnect the computing units 104 in the first computer enclosure 102a from the data network 108. In one embodiment, the administrator 121 can disconnect the computing units 104 from the data network 108 by issuing a shutdown command (not shown) to the first network device 106a via the management network 109. As a result, the first network device 106a can power down to disconnect the computing units 104 in the first computer enclosure 102a from the data network 108. In another embodiment, the administrator 121 can instruct a technician to physical unplug suitable cables between the first network device 106a and the computing units 104 in the first computer enclosure 102a. In further embodiments, disconnection from the data network 108 can be effected by diverting network traffic from the first network device 106a or via other suitable techniques.

Once the computing units 104 in the first computer enclosure 102a are disconnected from the data network 108, the administrator 121 can issue an erasure instruction 140 to the first enclosure controller 105a. In certain embodiments, the erasure instruction 140 can include a list of one or more computing units 104 in the first computer enclosure 102a to which secure data erasure is to be performed. The one or more computing units 104 can be identified by a serial number, a physical location, a network address, a media access control address (“MAC” address) or other suitable identifications. In other embodiments, the erasure instruction 140 can include a command to erase all computing units 104 in the first computer enclosure 102a. In further embodiments, the erasure instruction 140 can identify a list of persistent storage devices (shown in FIGS. 3A-3B) contained in one or more computing units 104 by serial numbers of other suitable identifications.

In response to receiving the erasure instruction 140, the first enclosure controller 105a can identify the one or more of the persistent storage devices and/or computing units 104 to perform secure data erasure. In certain embodiments, the first enclosure controller 105a can also request confirmation and/or authentication from the administrator 121 before initiating secure data erasure. For example, the enclosure controller 105a can request the administrator 121 to provide a secret code, password, or other suitable credential before proceeding with the secure data erasure. In other examples, the first enclosure controller 105a can also request direct input (e.g., via a key/lock on the first enclosure controller 105a) for confirmation of the instructed secure data erasure.

Upon proper authentication and/or confirmation, the first enclosure controller 105a can enumerate or identify all persistent storage devices attached or connected to the computing units 104 in the first computer enclosure 102a. In one embodiment, such enumeration can be include querying the individual computing units 104 via, for instance, an Intelligent Platform Management Interface (“IPMI”) with the computing units 104 and/or persistent storage devices connected thereto. In other embodiments, such enumeration can also include retrieving records of previously detected persistent storage devices from a database (not shown), or via other suitable techniques.

Once the first enclosure controller 105a identifies the list of connected persistent storage devices and the list to be erased, the first enclosure controller 105a can transmit erasure commands 142 to one or more of the computing units 104 via the same IPMI or other suitable interfaces via a system management bus (“SMBus”), an RS-232 serial channel, an Intelligent Platform Management Bus (“IPMB”), or other suitable connections with the individual computing units 104. In response to the erasure commands 142, the individual computing units 104 can perform suitable secure data erasure, as described in more detail below with reference to FIGS. 3A-3B. In one embodiment, the computing units 104 can perform secure data erasure generally in parallel. As such, secure data erasure can be performed on more than one computing units 104 at the same time. In other embodiments, secure data erasure can be performed in staggered or other suitable manners.

As shown in FIG. 2B, once secure data erasure is completed, the individual computing units 104 can transmit erasure report 144 to the first enclosure controller 105a via the same IPMI or other suitable interfaces. In certain embodiments, the erasure report 144 can include data indicating a failure, a successful completion, or a non-performance of the requested secure data erasure on one or more persistent storage devices. In other embodiments, the erasure report 144 can also include data indicating a start time, an elapsed period, a complete time, an error code, or other suitable information related to the secure data erasure performed on one or more persistent storage devices. The first enclosure controller 105a can then aggregate the received erasure report 144 from the individual computing units 104 and transmit an aggregated erasure report 144′ to the administrator 121 via the management network 109. Based on the received aggregated erasure report 144′, the administrator 121 can then identify one or more of the computing units 104 and/or persistent storage devices for manual inspection, hardware recycles, or other suitable operations.

Even though FIGS. 2A and 2B illustrate operations of performing secure data erasure on computing units 104 in a single computer enclosure 105, in other embodiments, secure data erasure can also be performed on computing units 104 in different computer enclosures 105 in generally a parallel manner. For example, as shown in FIG. 2C, in certain embodiments, the erasure instruction 140 can also identify one or more computing units 104 in one or more other computer enclosures 102 to perform secure data erasure.

In response, the first enclosure controller 105a can identify one or more other enclosure controller 105 for relaying the erasure instruction 140. For example, in the illustrated embodiment, the first enclosure controller 105 can identify both the second and third enclosure controllers 105b and 105c based on the received erasure instruction 140. As such, the first enclosure controller 105a can relay the erasure instruction 140 to both the second and third enclosure controllers 105b and 105c. In turn, the second and third enclosure controllers 105b and 105c can be configured to enumerate connected persistent storage devices and issue erasure commands 142 generally similarly to the operations described above with reference to the first enclosure controller 105a. In other embodiments, the erasure instruction 140 can be relayed in a daisy chain. For instance, as shown in FIG. 2C, instead of transmitting the erasure instruction 140 from the first enclosure controller 105a, the second enclosure controller 105b can relay the erasure instruction 140 to the third enclosure controller 105c. In further embodiments, the administrator 121 can issue erasure instructions 140 to all first, second, and third enclosure controllers 105 individually.

As shown in FIG. 2D, once secure data erasure is completed, the individual computing units 104 in the second and third computer enclosures 102b and 102c can transmit erasure report 144 to the second and third enclosure controllers 105b and 105c, respectively. The second and third enclosure controllers 105b and 105c can in turn aggregate the erasure reports 144 and transmit the aggregated erasure reports 144′ to the first enclosure controller 105a. The first enclosure controller 105a can then aggregate all received erasure reports 144 and provide the aggregated erasure report 144′ to the administrator 121, as described above with reference to FIG. 2B.

Several embodiments of the disclosed technology can thus efficiently and cost-effectively perform secure data erasure on multiple computing units 104 in the computing system 100. For example, relaying the erasure instructions 140 via the enclosure controllers 105 can allow performance of secure data erasure of multiple computing units 104, racks of computing units 104, or clusters of computing units 104 in parallel, staggered, or in other suitable manners. Also, the foregoing secure data erasure technique generally does not involve manual intervention by technicians or the administrator 121. As such, several embodiments of the disclosed secure data erasure can be efficient and cost effective.

FIGS. 3A-3B are block diagrams illustrating certain hardware/software components of a computing unit 104 suitable for the computing system 100 of FIG. 1 during certain stages of secure data erasure in accordance with embodiments of the disclosed technology. Though FIGS. 3A-3B only show certain components of the computing unit 104, in other embodiments, the computing unit 104 can also include network interface modules, expansion slots, and/or other suitable mechanical/electrical components.

As shown in FIG. 3A, the computing unit 104 can include a motherboard 111 carrying a main processor 112, a main memory 113, a memory controller 114, one or more persistent storage devices 124 (shown as first and second persistent storage devices 124a and 124b, respectively), an auxiliary power source 128, and a BMC 132 operatively coupled to one another. The motherboard 111 can also carry a main power supply 115, a sensor 117 (e.g., a temperature or humidity sensor), and a cooling fan 119 (collectively referred to as “peripheral devices”) coupled to the BMC 132.

Though FIGS. 3A-3B only show the motherboard 111 in phantom lines, the motherboard 111 can include a printed circuit board with one or more sockets configured to receive the foregoing or other suitable components described herein. In other embodiments, the motherboard 111 can also carry indicators (e.g., light emitting diodes), communication components (e.g., a network interface module), platform controller hubs, complex programmable logic devices, and/or other suitable mechanical and/or electric components in lieu of or in addition to the components shown in FIGS. 3A-3B. In further embodiments, the motherboard 111 can be configured as a computer assembly or subassembly having only portions of those components shown in FIGS. 3A-3B. For example, the motherboard 111 can form a computer assembly containing only the main processor 112, main memory 113, and the BMC 132 without the persistent storage devices 124 being received in corresponding sockets. In other embodiments, the motherboard 111 can also be configured as another computer assembly with only the BMC 132. In further embodiments, the motherboard 111 can be configured as other suitable types of computer assembly with suitable components.

The main processor 112 can be configured to execute instructions of one or more computer programs by performing arithmetic, logical, control, and/or input/output operations, for example, in response to a user request received from the client device 103 (FIG. 1). As shown in FIG. 3A, the main processor 112 can include an operating system 123 configured to facilitate execution of applications (not shown) in the computing unit 104. In other embodiments, the main processor 112 can also include one or more processor cache (e.g., L1 and L2 cache), a hypervisor, or other suitable hardware/software components.

The main memory 113 can include a digital storage circuit directly accessible by the main processor 112 via, for example, a data bus 107. In one embodiment, the data bus 107 can include an inter-integrated circuit bus or I²C bus as detailed by NXP Semiconductors N. V. of Eindhoven, the Netherlands. In other embodiments, the data bus 107 can also include a PCIE bus, system management bus, RS-232, small computer system interface bus, or other suitable types of control and/or communications bus. In certain embodiments, the main memory 113 can include one or more DRAM modules. In other embodiments, the main memory 113 can also include magnetic core memory or other suitable types of memory for holding data 118.

The persistent storage devices 124 can include one or more non-volatile memory devices operatively coupled to the memory controller 114 via another data bus 107′ (e.g., a PCIE bus) for persistently holding data 118. For example, the persistent storage devices 124 can each include an SSD, HDD, or other suitable storage components. In the illustrated embodiment, the first and second persistent storage devices 124a and 124b are connected to the memory controller 114 via data bus 107′ in parallel. In other embodiments, the persistent storage devices 124 can also be connected to the memory controller 112 in a daisy chain or in other suitable topologies. In the example shown in FIGS. 3A-3B, two persistent storage devices 124 are shown for illustration purposes only. In other examples, the computing unit 104 can include four, eight, sixteen, twenty four, forty eight, or any other suitable number of persistent storage devices 124.

Also shown in FIG. 3A, each of the persistent storage device 124 can include data blocks 127 containing data 118 and a device controller 125 configured to monitor and/or control operations of the persistent storage device 124. For example, in one embodiment, the device controller 125 can include a flash memory controller, a disk array controller (e.g., a redundant array of inexpensive disk or “RAID” controller), or other suitable types of controller. In other embodiments, a single device controller 125 can be configured to control operations of multiple persistent storage devices 124. As shown in FIG. 2A, the individual device controller 125 can be in communication with the BMC 132 via a management bus 131 (e.g., SMBus) to facilitate secure data erasure, as described in more detail below.

Also shown in FIG. 3A, the main processor 112 can be coupled to a memory controller 114 having a buffer 116. The memory controller 114 can include a digital circuit that is configured to monitor and manage operations of the main memory 113 and the persistent storage devices 124. For example, in one embodiment, the memory controller 114 can be configured to periodically refresh the main memory 113. In another example, the memory controller 114 can also continuously, periodically, or in other suitable manners read data 118 from the main memory 113 to the buffer 116 and transmit or “write” data 118 in the buffer 116 to the persistent storage devices 124. In the illustrated embodiment, the memory controller 114 is separate from the main processor 112. In other embodiments, the memory controller 114 can also include a digital circuit or chip integrated into a package containing the main processor 112. One example memory controller is the Intel® 5100 memory controller provided by the Intel Corporation of Santa Clara, Calif.

The BMC 132 can be configured to monitor operating conditions and control device operations of various components on the motherboard 111. As shown in FIG. 3A, the BMC 132 can include a BMC processor 134, a BMC memory 136, and an input/output component 138 operatively coupled to one another. The BMC processor 134 can include one or more microprocessors, field-programmable gate arrays, and/or other suitable logic devices. The BMC memory 136 can include volatile and/or nonvolatile computer readable media (e.g., ROM, RAM, magnetic disk storage media, optical storage media, flash memory devices, EEPROM, and/or other suitable non-transitory storage media) configured to store data received from, as well as instructions for, the processor 136. In one embodiment, both the data and instructions are stored in one computer readable medium. In other embodiments, the data may be stored in one medium (e.g., RAM), and the instructions may be stored in a different medium (e.g., EEPROM). As described in more detail below, in certain embodiments, the BMC memory 136 can contain instructions executable by the BMC processor 134 to perform secure data erasure in the computing unit 104. The input/output component 124 can include a digital and/or analog input/output interface configured to accept input from and/or provide output to other components of the BMC 132. One example BMC is the Pilot 3 controller provided by Avago Technologies of Irvine, Calif.

The auxiliary power source 128 can be configured to controllably provide an alternative power source (e.g., 12-volt DC) to the main processor 112, the memory controller 114, and other components of the computing unit 104 in lieu of the main power supply 115. In the illustrated embodiment, the auxiliary power source 128 includes a power supply that is separate from the main power supply 115. In other embodiments, the auxiliary power source 128 can also be an integral part of the main power supply 115. In further embodiments, the auxiliary power source 128 can include a capacitor sized to contain sufficient power to write all data from the portion 122 of the main memory 113 to the persistent storage devices 124. As shown in FIG. 2A, the BMC 132 can monitor and control operations of the auxiliary power source 128.

The peripheral devices can provide input to as well as receive instructions from the BMC 132 via the input/output component 138. For example, the main power supply 115 can provide power status, running time, wattage, and/or other suitable information to the BMC 132. In response, the BMC 132 can provide instructions to the main power supply 115 to power up, power down, reset, power cycle, refresh, and/or other suitable power operations. In another example, the cooling fan 119 can provide fan status to the BMC 132 and accept instructions to start, stop, speed up, slow down, and/or other suitable fan operations based on, for example, a temperature reading from the sensor 117. In further embodiments, the motherboard 111 may include additional and/or different peripheral devices.

FIG. 3A shows an operating stage in which the BMC 132 receives an erasure command 142 from the enclosure controller 105 via, for example, the input/output component 138. In response, the BMC 132 can be configured to identify a list of persistent storage devices 124 currently connected to the motherboard 111 by querying the device controllers 125 via, for instance, the management bus 131. Once identified, the BMC 132 can be configured to issue erase orders 146 via the input/output component 138 to one or more of the device controllers 125 corresponding to a persistent storage device 124 to be erased.

In certain embodiments, the erase orders 146 can cause the individual persistent storage devices 124 to reformat all data blocks 127 therein. In other embodiments, the erase orders 146 can cause a predetermined data pattern (e.g., all zeros or ones) be written into the data blocks 127 to overwrite any existing data 118 in the persistent storage devices 124. In further embodiments, the erase orders 146 can also cause the persistent storage devices 124 to operate abnormally (e.g., overspinning) to cause mechanical damage to the persistent storage devices 124. In yet further embodiments, the erase orders 146 can cause the persistent storage devices 124 to remove or otherwise render irretrievable any existing data 118 in the persistent storage devices 124.

In certain implementations, the BMC 132 can issue erase orders 146 that cause the first and second persistent storage devices 124a and 124b to perform the same data erasure operation (e.g., reformatting). In other implementations, the BMC 132 can be configured to determine a data erasure technique corresponding to a level of business importance related to the data 118 currently residing in the persistent storage devices 124. For example, the first persistent storage device 124a can contain data 118 of high business importance while the second persistent storage device 124b can contain data 118 of low business importance. As such, the BMC 132 can be configured to generate erase orders 146 to the first and second persistent storage devices 124 instructing different data erasure techniques. For instance, the BMC 132 can instruct the first persistent storage device 124a to format the corresponding memory block 127 a higher number of times than the second persistent storage device 124b. In other examples, the BMC 132 can also instruct the first persistent storage device 124a to perform different data erasure technique (e.g., reformatting and then overwriting with predetermined data patterns) than the second persistent storage device 124b. In yet further examples, the BMC 132 can also cause the first persistent storage device 132a to overspin and intentionally crash the persistent storage device 124a.

As shown in FIG. 3B, once data erasure is completed, existing data 118 (shown in FIG. 3A) can be removed from the data blocks 127 (shown in patterns). The device controllers 125 can then transmit erasure results 148 to the BMC 132 via the management bus 131. The BMC 132 can then aggregate the erasure results 148 into an erasure report 144 and provide the erasure report 144 to the enclosure controller 105 via the management network 109 (FIG. 1). The enclosure controller 105 can then collect the erasure report 144 from the individual BMCs 132 and provide an aggregated erasure report 144′ to the administrator 121 (FIG. 1) as described above with reference to FIG. 2B.

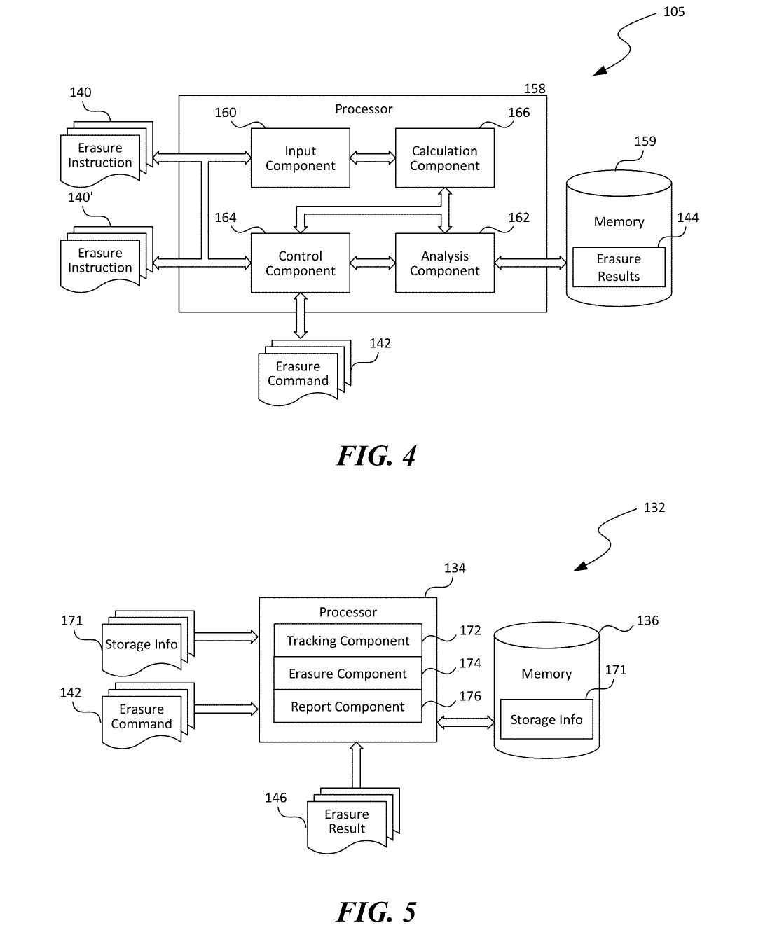

FIG. 4 is a block diagram of the enclosure controller 150 suitable for the computing system 100 in FIG. 1 in accordance with embodiments of the disclosed technology. In FIG. 4 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit, or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 4, the enclosure controller 105 can include a processor 158 operatively coupled to a memory 159. The processor 158 can include one or more microprocessors, field-programmable gate arrays, and/or other suitable logic devices. The memory 159 can include volatile and/or nonvolatile computer readable media (e.g., ROM, RAM, magnetic disk storage media, optical storage media, flash memory devices, EEPROM, and/or other suitable non-transitory storage media) configured to store data received from, as well as instructions for, the processor 158. For example, as shown in FIG. 4, the memory 159 can contain records of erasure reports 144 received from, for example, one or more of the computing units 104 in FIG. 1. The memory 159 can also contain instructions executable by the processor 158 to provide an input component 160, a calculation component 166, a control component 164, and an analysis component 162 interconnected with one another. The input component 160 can be configured to receive erasure instruction 140 from the administrator 121 (FIG. 1) via the management network 109. The input component 160 can then provide the received erasure instruction 140 to the analysis component 162 for further processing.

The calculation component 166 may include routines configured to perform various types of calculations to facilitate operation of other components of the enclosure controller 105. For example, the calculation component 166 can include routines for accumulating a count of errors detected during secure data erasure. In other examples, the calculation component 166 can include linear regression, polynomial regression, interpolation, extrapolation, and/or other suitable subroutines. In further examples, the calculation component 166 can also include counters, timers, and/or other suitable routines.

The analysis component 162 can be configured to analyze the received erasure instruction 140 to determine whether or to which computing units 104 to perform secure data erasure. In certain embodiments, the analysis component 162 can determine a list of computing units 104 based on one or more serial numbers, network identifications, or other suitable identification information associated with one or more persistent storage devices 124 (FIG. 3A) and/or computing units 104. In other embodiments, the analysis component 162 can make the determination based on a remaining useful life, a percentage of remaining useful life, or other suitable information and/or criteria associated with the one or more persistent storage devices 124.

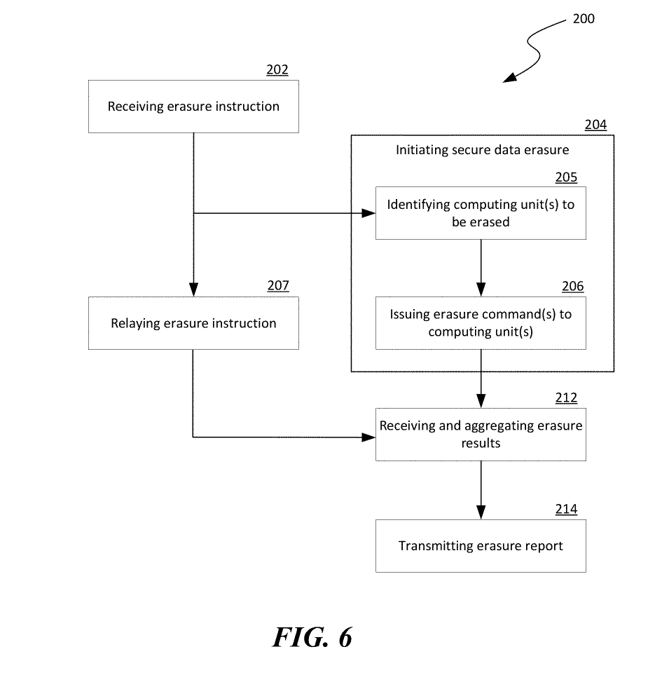

The control component 164 can be configured to control performance of secure data erasure in the computing units 104. In certain embodiments, the control component 164 can issue erasure command 142 to a device controller 125 (FIG. 3A) of the individual persistent storage devices 124. In other embodiments, the control component 164 can also cause the received erasure instruction 140′ be relayed to other enclosure controllers 105. Additional functions of the various components of the enclosure controller 105 are described in more detail below with reference to FIG. 6.

FIG. 5 is a block diagram of a BMC 132 suitable for the computing unit 104 in FIG. 1 in accordance with embodiments of the disclosed technology. As shown in FIG. 5, the BMC processor 134 can execute instructions in the BMC memory 136 to provide a tracking component 172, an erasure component 174, and a report component 176. The tracking component 172 can be configured to track one or more persistent storage devices 124 (FIG. 3A) connected to the motherboard 111 (FIG. 3A). In the illustrated embodiment, the persistent storage devices 124 can provide storage information 171 to the BMC 132 on a periodic or other suitable basis. In other embodiments, the tracking component 172 can query or scan the motherboard 111 for existing, new, or removed persistent storage devices 124. The tracking component 172 can then store the received storage information in the BMC memory 136 (or other suitable storage locations).

The erasure component 174 can be configured to facilitate performance of secure data erasure on a persistent storage device 124 upon receiving an erasure command 142 from, for example, the enclosure controller 105 (FIG. 1). In certain embodiments, the erasure component 174 can be configured to initiate a secure data erasure operation, monitor progress of the initiated operation, and indicate to the report component 176 at least one of a failure, successful completion, or no response. In turn, the report component 176 can be configured to generate the erasure result 146 and provide the generated erasure result 146 to the enclosure controller 105.

FIG. 6 is a flowchart illustrating a process 200 of performing secure data erasure in a computing system in accordance with embodiments of the disclosed technology. Even though the process 200 is described in relation to or in the context of the computing system 100 of FIG. 1 and the hardware/software components of FIGS. 2A-3B, in other embodiments, the process 200 can also be implemented in other suitable systems.

As shown in FIG. 6, the process 200 can include receiving an erasure instruction via a management network at stage 202. The process 200 can then include initiating secure data erasure in the current enclosure at stage 204 and concurrently proceeds to relaying the received erasure instruction to additional enclosure controllers at stage 207. As shown in FIG. 6, initiating secure data erasure in the current enclosure can include identifying one or more computing units whose connected persistent storage devices are to be erased at stage 205. In one embodiment, the one or more computing units can be identified by serial numbers associated with the persistent storage devices and/or the computing units. In other embodiments, the one or more computing units can be identified based on MAC addresses or other suitable identifications. The process 200 can then proceed to issuing erasure commands to the one or more computing units at stage 206 and receiving erasure results from the computing units at stage 212. The process 200 can then include aggregating the received erasure results to generate an erasure report and transmitting the erasure report to, for example, an administrator via the management network.

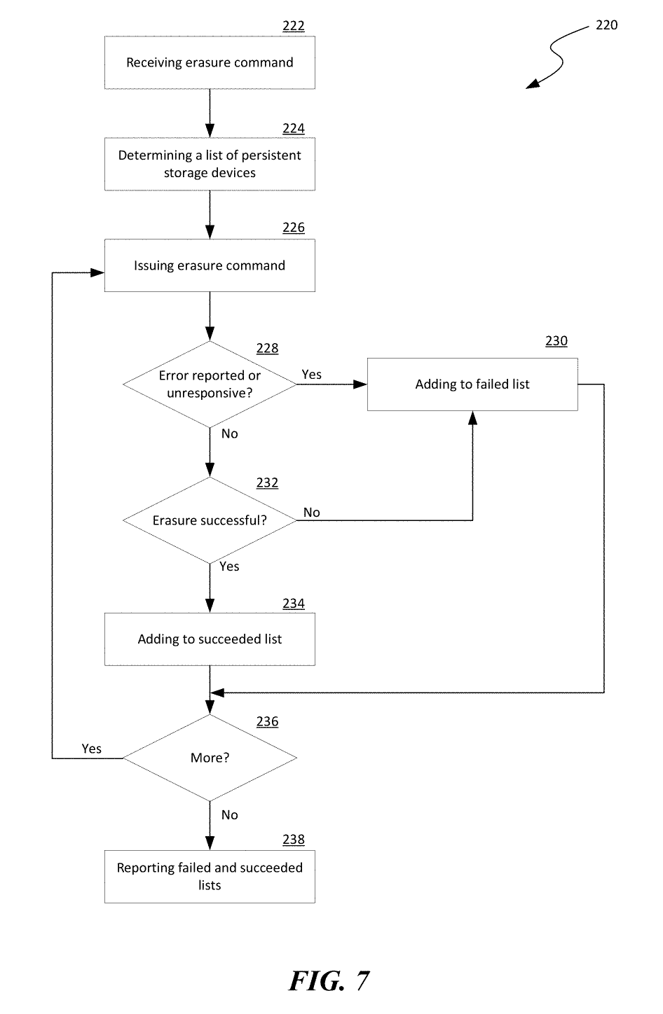

FIG. 7 is a flowchart illustrating a process 220 of performing secure data erasure in a computing system in accordance with embodiments of the disclosed technology. As shown in FIG. 7, the process 220 can include receiving an erasure command from, for example, an enclosure controller 105 in FIG. 1, at stage 222. The process 220 can then optionally include determining a list of persistent storage devices currently connected at stage 224. For one of the identified persistent storage devices, the process 220 can then include issuing an erasure command to erase all data from the persistent storage device at stage 226.

The process 220 can then include a decision stage 228 to determine whether the persistent storage device reports data erasure error (e.g., data erasure prohibited) or the persistent storage device is non-responsive to the erasure command. In response to determining that an error is reported or the persistent storage device is non-responsive, the process 220 proceeds to adding the persistent storage device to a failed list at stage 230. Otherwise, the process 220 proceeds to another decision stage 232 to determine whether the data erasure is completed successfully. In response to determining that the data erasure is not completed successfully, the process 220 reverts to adding the persistent storage device to the failed list at stage 230. Otherwise, the process 220 proceeds to adding the persistent storage device to a succeeded list at stage 234. The process 220 can the include a further decision stage 236 to determine whether erasure commands need to be issued to additional persistent storage devices. In response to determining that erasure commands need to be issued to additional persistent storage devices, the process 220 can revert to issuing another erasure command to another persistent storage device at stage 226. Otherwise, the process 220 can proceed to generate and transmitting an erasure report containing data of the failed and succeeded lists at stage 238.

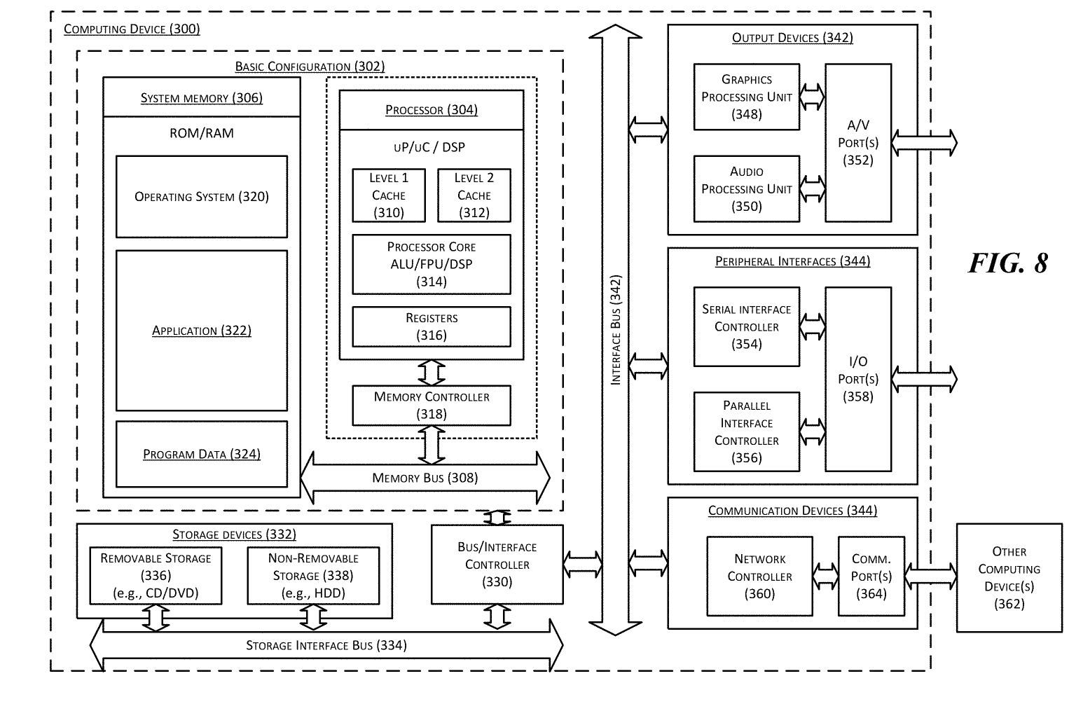

FIG. 8 is a computing device 300 suitable for certain components of the computing system 100 in FIG. 1. For example, the computing device 300 can be suitable for the computing units 104, the client devices 103, the management station 103′, or the enclosure controllers 105 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. As shown in FIG. 8, the operating system 320 can include a hypervisor 140 for managing one or more virtual machines 144. This described basic configuration 302 is illustrated in FIG. 8 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more AN ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

Specific embodiments of the technology have been described above for purposes of illustration. However, various modifications can be made without deviating from the foregoing disclosure. In addition, many of the elements of one embodiment can be combined with other embodiments in addition to or in lieu of the elements of the other embodiments. Accordingly, the technology is not limited except as by the appended claims.

I/We claim:

1. A method performed by a computing device in a computing system having a plurality of servers housed in an enclosure, the method comprising:
receiving, at the computing device, an erasure instruction from a system administrator via a management network in the computing system, the management network being configured to control device operations of the servers independent of execution of any firmware or operating system by a processor of the individual servers; and
in response to and based on the received erasure instruction,
identifying one or more servers in the enclosure to which data erasure is to be performed; and
transmitting an erasure command to the individual one or more identified servers via a network interface between the computing device and the individual servers, the erasure command instructing the identified servers to perform secure data erasure on one or more persistent storage devices of the identified servers, thereby securely erasing data residing on the one or more persistent storage devices without manual intervention.

2. The method of claim 1 wherein receiving the erasure instruction includes receiving the erasure instruction via the management network while the servers are disconnected from a data network in the computing system, the management network being independent of the data network.

3. The method of claim 1, further comprising:
receiving, from the individual servers, an erasure report indicating an error, a failure, or a successful completion related to the secure data erasure performed on the individual servers;
generating an aggregated erasure report based on the erasure reports received from the individual servers; and
transmitting the aggregated erasure report to the system administrator via the management network.

4. The method of claim 1 wherein:
the computing device is a first computing device;
the enclosure is a first enclosure;
the computing system also includes a second enclosure housing a second computing device and a plurality of additional servers; and
the method further includes relaying, from the first computing device, the received erasure instruction to the second computing device to perform secure data erasure on one or more of the additional servers in the second enclosure generally in parallel to performing secure data erasure on the identified servers in the first enclosure.

5. The method of claim 4, further comprising:
receiving, from the second computing device, an erasure report indicating an error, a failure, or a successful completion related to the secure data erasure performed on the one or more additional servers in the second enclosure;
generating an aggregated erasure report based on the erasure report received from the second computing device and the erasure reports received from the individual servers in the first enclosure; and
transmitting the aggregated erasure report to the system administrator via the management network.

6. The method of claim 4 wherein:
the computing system also includes a third enclosure housing a third computing device and a plurality of additional servers; and
the method further includes relaying, from the second computing device, the erasure instruction to the third computing device to perform secure data erasure on one or more of the additional servers in the third enclosure generally in parallel to performing secure data erasure on the servers in the first and second enclosures.

7. The method of claim 4 wherein:
the computing system also includes a third enclosure housing a third computing device and a plurality of additional servers; and
the method further includes relaying, from the first computing device, the erasure instruction to both the second and third computing devices to perform secure data erasure on one or more of the additional servers in the second and third enclosures generally in parallel to performing secure data erasure on the servers in the first enclosure.

8. A computing device, comprising:
a baseboard management controller (“BMC”); and
a persistent storage device operatively coupled to the BMC, wherein the BMC includes a processor and a memory containing instructions executable by the processor to cause the processor to perform a process comprising:
receiving an erasure command to erase data from the persistent storage device via a management network; and
in response to the received erasure command,
identifying the persistent storage device to which data erasure is to be performed; and
transmitting an erase order to the persistent storage device via a management interface between the BMC and the persistent storage device, the erasure order instructing the persistent storage device to render irretrievable any data currently residing in the persistent storage device, thereby effecting secure data erasure on the persistent storage device without manual intervention.

9. The computing device of claim 8 wherein:
the persistent storage device includes a device controller and a memory block containing data; and
transmitting the erase order to the persistent storage device includes transmitting the erase order to the device controller of the persistent storage device, the erase order instructing the device controller to erase the data in the memory block.

10. The computing device of claim 8 wherein:
the persistent storage device includes a device controller and a memory block containing data; and
transmitting the erase order to the persistent storage device includes transmitting the erase order to the device controller of the persistent storage device, the erase order instructing the device controller to erase the data in the memory block and to report an erasure result of a failure, successful completion, or non-performance of secure data erasure in the memory block.

11. The computing device of claim 8 wherein:
receiving the erasure command includes receiving the erasure command to erase data from the persistent storage device from an enclosure controller via a management network;
the persistent storage device includes a device controller and a memory block containing data;
transmitting the erase order to the persistent storage device includes transmitting the erase order to the device controller of the persistent storage device, the erase order instructing the device controller to erase the data in the memory block and to report an erasure result indicating a failure, a successful completion, or non-performance of secure data erasure in the memory block; and
generating an erasure report based on the received erasure result and transmitting the generated erasure report to the enclosure controller.

12. The computing device of claim 8 wherein:
the persistent storage device includes a device controller and a memory block containing data;
transmitting the erase order to the persistent storage device includes transmitting the erase order to the device controller of the persistent storage device, the erase order instructing the device controller to erase the data in the memory block and to report an erasure result of a failure, successful completion, or non-performance of secure data erasure in the memory block;
based on the received erasure report, determining whether secure data erasure is completed in the persistent storage device; and
in response to determining that secure data erasure is completed in the persistent storage device, adding the persistent storage device to a succeeded list of persistent storage devices.

13. The computing device of claim 12, further comprising in response to determining that secure data erasure is not completed successfully in the persistent storage device, adding the persistent storage device to a failed list of persistent storage devices.

14. The computing device of claim 12, further comprising in response to determining that secure data erasure is not completed successfully in the persistent storage device, adding the persistent storage device to a failed list of persistent storage devices and generating an erasure report based on the received erasure result containing the succeeded list and the failed list and transmitting the generated erasure report to the enclosure controller.

15. The computing device of claim 8 wherein:
the persistent storage device includes a device controller and a memory block containing data; and
transmitting the erase order to the persistent storage device includes transmitting the erase order to the device controller of the persistent storage device, the erase order instructing the device controller to perform at least one of formatting the memory block a predetermined number of time or overwriting existing data in the memory block with a predetermined data pattern.

16. The computing device of claim 8 wherein:
the persistent storage device includes a device controller and a memory block containing data; and
the process performed by the processor further includes determining a level of business importance of the data in the memory block and selecting a data erasure technique in accordance with the determined level of business importance of the data; and
transmitting the erase order to the persistent storage device includes transmitting the erase order to the device controller of the persistent storage device, the erase order instructing the device controller to perform the selected data erasure technique to the data in the memory block.

17. The computing device of claim 8 wherein:
the persistent storage device includes a device controller and a memory block containing data;
the process performed by the processor further includes determining a level of business importance of the data in the memory block and selecting a method by which to erase the memory block in accordance with the determined level of business importance of the data; and
transmitting the erase order to the persistent storage device includes transmitting the erase order to the device controller of the persistent storage device, the erase order instructing the device controller to apply the selected method to erase the memory block.

18. A baseboard management controller (“BMC”), comprising:
a processor and a memory containing instructions executable by the processor to cause the processor to perform a process comprising:
receiving a command to erase data from a persistent storage device operatively coupled to the BMC via a management bus; and
in response to the received command,
determining a data erasure operation to be performed on the persistent storage device based on a level of business importance of the data currently residing on the persistent storage device; and
transmitting an erase order to the persistent storage device via the management bus between the BMC and the persistent storage device, the erasure order instructing the persistent storage device to apply the determined data erasure operation on the data currently residing on the persistent storage device, thereby effecting secure data erasure on the persistent storage device.

19. The BMC of claim 18 wherein:
the persistent storage device includes a device controller configured to control data operations of a corresponding memory block; and
transmitting the erase order includes transmitting the erase order to the persistent storage device via a management interface between the BMC and the device controller of the persistent storage device.

20. The BMC of claim 18 wherein the process performed by the processor further includes receiving a feedback from the persistent storage device regarding a failure, successful completion, or non-performance of the determined data erasure operation and indicating to a system administrator regarding the failure, successful completion, or non-performance of the determined data erasure operation based on the received feedback.
